(19) United States
(12) Patent Application Publication
(10) Pub. No.: US 2006/0230041 A1
(43) Pub. Date: Oct. 12, 2006

(54) System and method for database access control

(76) Inventor: Everett M. Sherwood, Scottsdale, AZ (US)

Correspondence Address: INGRASSIA FISHER & LORENZ, P.C., 7150 E. CAMELBACK, STE. 325, SCOTTSDALE, AZ, 85251, US

(21) Appl. No.: 11/093,432

(22) Filed: Mar. 29, 2005

(51) Int. Cl. G06F 17/30; G06F 7/00

(52) U.S. Cl. 707/8

(57) ABSTRACT

A system and method for controlling access to components in a database is provided. The system and method provides flexible access control with variable granularity using a generalized mapping model (GMM) transform of data from one or more databases into a plurality of GMM objects, and mapping the GMM objects to access control settings using an access control mapping. The database access control system and method uses the structures of objects created by the GMM transform to identify and facilitate selective access control to any part or combination of components in the database, including the data and implicit relationships among data. The system and method facilitates individual control of the security permissions and conditions for the components using one or more access control maps to define which data components and relationships different access control procedures are applied.

### FIELD OF THE INVENTION

This invention generally relates to data management and, more specifically relates to systems and methods for data security.

### BACKGROUND OF THE INVENTION

In modern society, information storage and retrieval is of critical importance efficient business operation. Modern computing practice has typically used specialized computer programs, generally called database management system (DBMS) to store, organize and retrieve data. Database management systems are the primary choice for storage of large amounts of information where efficiency and access to the data by multiple users is the main focus.

A modern database management system can be implemented to include extremely large amounts of data from a wide range of sources. For example, the database management system may be implemented to combine information from multiple organizations, such as telephone networks, inter-governmental agencies, multi-vendor manufacturing systems, etc. Furthermore, database management systems can be implemented to cover multiple domains, such as finance, inventory and communications. In all these cases the database management system can be required to store large amounts of data from a wide range of sources.

One important issue in database management system technology is access control. In general, access control refers the mechanisms and policies that restrict access to information stored in the database. For example, access control refers to the mechanisms that determine which users of a database have the ability to access and/or modify particular pieces of data in the database.

However, in many database management systems the ability to provide access control for information in the database is limited. For example, some databases provide only basic permission control, such as read, write, append and delete. Furthermore, some databases provide limited resolution in access control. For example, some databases only provide the ability to specify access control at the data record level. This capability can be insufficient where it is desirable that different fields within the record be provided with different levels of access control to different users. Thus, what is needed is a system and method for improved for database access control.

### BRIEF SUMMARY OF THE INVENTION

The present invention provides a system and method for controlling access to components in a database. The system and method provides flexible access control with variable granularity using a generalized mapping model (GMM) transform of data from one or more databases into a plurality of GMM objects, and maps the GMM objects to access control settings using an access control mapping.

In general, a GMM transform restructures the database, including the data and domain structure information (schema) of the database. Specifically, the GMM transform recomposes the database into new components such that it identifies components of the database as objects and further identifies the domain structure information of the database as separate objects. In transforming the domain structure the GMM transform identifies implicit structural relationships among components and identifies these relationships as objects, making the implicit relationships in the domain structure explicit. The GMM transform places these objects into a set of canonical structures, which together fully describe the data components and domain structure of the database. The GMM transform can be used to provide multiple simultaneous expressions of the database domain structure and correspondingly provides access to the data through those different expressions. These multiple simultaneous expressions provide a mechanism for multiple clients autonomously restructure both the data and the domain model of the database.

The database access control system and method uses the structures of objects created by the GMM transform to identify and facilitate selective access control to any part or combination of components in the database, including the data and implicit relationships among data. The system and method facilitates individual control of the security permissions and conditions for the components using one or more access control maps to identify which data components and relationships to which different access control procedures are applied. The access control maps specify the permissions and/or conditions that apply to the data and relationships in the GMM transformed data, and can be combined to provide flexible access control. The system and method can facilitate selective access control at any level of resolution, from the lowest levels of granularity in the system (e.g., the cell level), to large groups of data (e.g., the class level), to class relationships within the domain. Furthermore, the system and method facilitates separate security control of both the implicit and explicit relationships among data in the underlying database without making any requirement for access control restrictions that are used in the relationship. Furthermore, by providing multiple access control maps to different clients the system and method allows different sets of permissions and conditions to be established for each of the clients which are unrelated to other permissions. The access control system and method thus provides flexible access control to the database.

### BRIEF DESCRIPTION OF DRAWINGS

The preferred exemplary embodiment of the present invention will hereinafter be described in conjunction with the appended drawings, where like designations denote like elements, and:

FIG. 1 is a schematic view of an access control system in accordance with a first embodiment of the invention;

FIG. 2 is a schematic view of an exemplary access control map in accordance with an embodiment of the invention;

FIG. 3 is a schematic view of a plurality of exemplary access control maps in accordance with an embodiment of the invention;

FIG. 4 is a schematic view of a combination of exemplary access control maps in accordance with an embodiment of the invention;

FIG. 5 is a schematic block diagram illustrating an exemplary network architecture employing a database and database management system;

FIG. 6 is a block diagram illustrating an exemplary relationship between a database and a database management system;

FIG. 7 is a schematic diagram of a database structure (and data) as provided by an exemplary a database management system;

FIG. 8 is a simplified block diagram depicting exemplary transformation of multiple databases into canonical structures of the generalized mapping model;

FIG. 9 is a simplified block diagram identifying seven exemplary generalized mapping model representation structures; and

FIG. 10 is an illustration of an array with labeled column headings as can be employed by an exemplary database management system.

### DETAILED DESCRIPTION OF THE INVENTION

The following description of the presently contemplated best mode of practicing the invention is not to be taken in a limiting sense, but is made merely for the purpose of describing the general principles of the invention. The scope of the invention should be determined with reference to the claims.

The present invention provides a system and method for controlling access to components of a database. The system and method provides flexible access control with variable granularity using a generalized mapping model (GMM) transform of the database into a plurality of GMM data objects, and mapping the GMM objects to access control settings using an access control maps.

In general, database is broadly defined as data stored in an organizational structure. A database can thus be considered to comprise two types of components, the data itself and the domain structure of the database. A GMM transform recomposes the database into new components such that it identifies these components into objects. Specifically, the GMM transform identifies the data components of the database as objects. Additionally, the GMM transform identifies the domain structure and nomenclature as objects. Thus, the GMM transform identifies the implicit structural relationships among components and identifies those relationships as objects, making the implicit relationships in the domain structure explicit. The GMM transform places these objects into a set of canonical structures. The GMM transform further provides a mechanism for multiple clients to autonomously restructure the data and domain model of the database. Thus, the GMM can be used to provide multiple simultaneous domain models, to enable comparison of data and domain models and to enable connection of domain information across multiple databases.

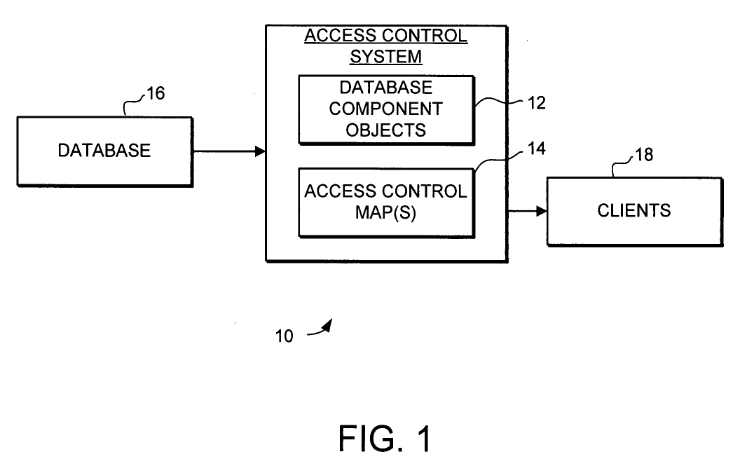

Turning now to FIG. 1, an access control system 10 is illustrated schematically. The access control system 10 includes database component objects 12 and access control maps 14. The database component objects 12 are created by the GMM transform to identify and facilitate selective access control to any part or combination of components in the database 16, including the data values and implicit relationships between data values. The access control maps 14 facilitate individual control of the security permissions and conditions for the components by defining the access control settings for the components.

The access control maps 14 specify the permissions and/or conditions that apply to the objects in the GMM transformed data, and can be combined to provide flexible access control. Thus, the access control system 10 can facilitate selective access control at any level of resolution, from the lowest levels of granularity in the data (e.g., the cell level), to large groups of data (e.g., the class level), to class relationships within the domain. Furthermore, the system 10 facilitates separate security control of both the implicit and explicit relationships among data in the underlying database, without making any requirement for the access control restrictions that are used in the relationship. Furthermore, by providing multiple access control maps to different clients 18 allows different sets of permissions and conditions to be established for the clients that are unrelated to other permissions. The access control system 10 thus provides flexible access control to the database.

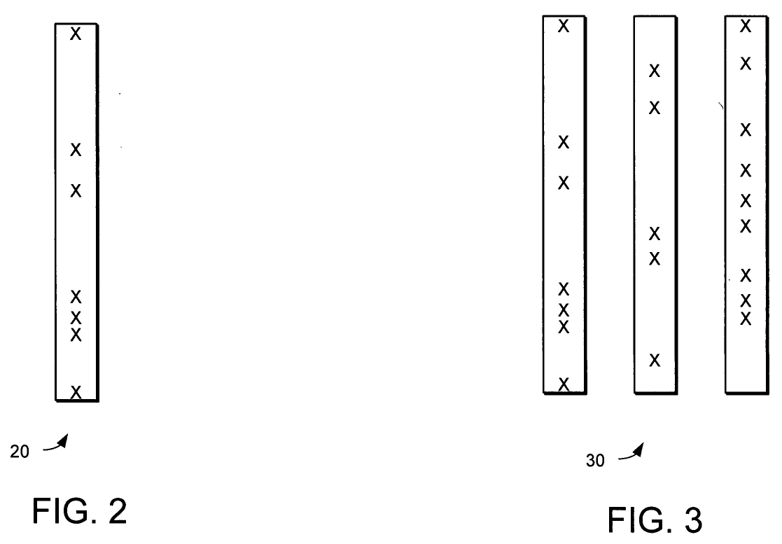

As stated above, the system and method uses' one or more access control maps to specify the control parameters that apply to the data values and relationships in the GMM transformed data, and can be combined to provide flexible access control. Turning now to FIG. 2, an exemplary access control map 20 is illustrated. The access control map 20 comprises a set of data used to specify an access control parameter, such as a condition or permission. An access control parameter is defined as a specification on the use of data by a user, where the user is a person or program accessing the data. One type of access control parameter is a control permission. An access control permission is defined as a specification of the actions the user may take with the data. Examples of access control permissions include “READ”, “WRITE”, “APPEND”, “READ ONLY”, “DELETE” and “GRANT”.

One type of access control parameter is an access control condition. An access control condition is defined as a specification on the availability of the data. Examples of access control conditions include “ON FRIDAY” and “FROM WITHIN NETWORK”.

The access control map specifies which objects in the GMM transform a corresponding control parameter applies to. As one example, the access control map 20 can comprise a bit map, with the bit map including a plurality of bits. In this embodiment, each of the plurality of bits is used to specify the access control parameter for one component in the GMM transformed data. Thus, the access control map 20 can be used to specify the access control conditions and permissions of the data values stored as objects in the GMM transform. Additionally, the access control map 20 can be used to specify the access control conditions and permissions for the domain information, including implicit relationships stored as objects in the GMM transform.

In the example illustrated in FIG. 2, each data value and domain information object in the GMM transform is assigned a bit position in the access control map 20. Thus, by selectively asserting (indicated by an X) and/or de-asserting the bits in the access control map the access control parameter can be applied to every object in the GMM transform. Thus, the parameter can be selectively applied to all data values and relationships that are stored as objects in the GMM transform.

Because the GMM transform creates objects at different resolutions, the access control map 20 can facilitate selective access control at any level of resolution within the data, from the lowest levels of granularity in the data (e.g., the cell level), to large groups of data (e.g., the class level), to class relationships within the domain. Furthermore, the access control map 20 facilitates separate security control of the implicit relationships among data in the underlying database, without requiring the same access control restrictions on the corresponding data values themselves.

It should be noted that the access control map 20 illustrated in FIG. 2 is a much simplified example, and that typical access control maps would be many times larger, with sufficient bit positions for all data and domain information stored as objects in the GMM transform.

Typically, an access control system would include a large number of access control maps 20, with each access control map 20 corresponding to one distinct type of access control parameter. Turning now to FIG. 3, a plurality of access control maps 30 is illustrated. Each of the plurality of access control maps specifies a different access control parameter, such as a permission or condition. Thus, one map can be used to specify which objects have the access control permission “READ ONLY”. Another map can then specify which objects have access control permissions DELETE, GRANT, etc.

Other maps can specify access control conditions, such as “ON FRIDAY” or “FROM WITHIN NETWORK”. Other maps can be used to specify conditions for particular users, such as for “XYZ CORP”. The plurality of maps 30 can be thus be used to specify the conditions and permissions that are applied to the objects in the GMM transform, and thus are used to specify access control parameters for both data values and domain information.

In some cases the plurality of access control maps 30 will include multiple different access control maps for different clients. This allows different sets of permissions and conditions to be established for the clients that are unrelated to other client permissions.

Again, the example plurality of access control maps is a much simplified example. A typical system would include many more access control maps to facilitate very fine control of access. Thus, a large number of different types of conditions and permissions can be specified for each object in the GMM transform the database.

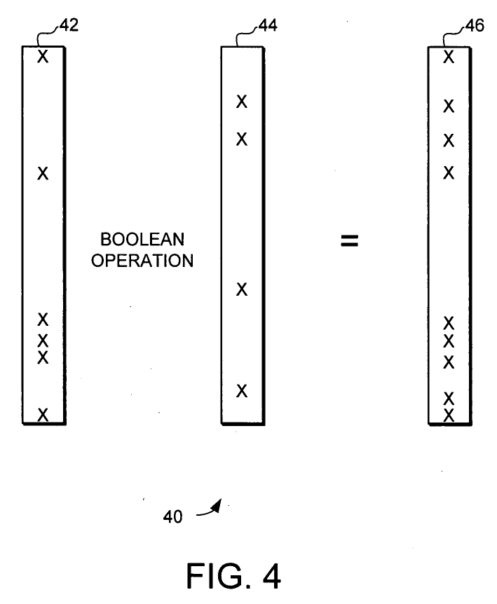

Additionally, the multiple access control maps can be selectively combined in varying combinations to provide a flexible, multi-resolution access control for components in the database. Turning now to FIG. 4, a combination 40 of access control maps is illustrated. In the example of FIG. 4, the access control maps are combined using a Boolean operation, such as OR, XOR, AND, NAND, etc. By combining selected access control maps using a Boolean operation, the access control parameters can be combined to create composite conditions. For example, the access control map 42 can specify components that are available in the fall, and access control map 44 can specify components that are available in the winter. When combined using an OR operation, the resulting composite map 406 will indicate those components that are available in fall or winter. Thus, multiple conditions can be combined using a Boolean operation of condition access control maps.

Likewise, control maps of permissions can be combined. For example, access control map 42 can specify components that are available for READ, and access control map 44 can specify components that are available for APPEND. When combined using an OR operation, the resulting composite map 46 would indicate those components that are available for READ or APPEND.

Control maps of permissions can likewise be combined with control maps of conditions. For example, access control map 42 can specify components that are available in the winter, and access control map 44 can specify components that are available for READ. When combined using an AND operation, the resulting composite map 46 would indicate those components that are available for READ in the winter.

Again, it should be noted that these are simplified examples. In many cases it would be desirable to combine more than two access control maps to create the composite control map.

In one embodiment, multiple sets of access control maps are provided. For example, different clients can be given different sets of access control maps. This provides the ability to give different clients different access control parameters. These different sets of access control maps can be stored with the clients, or as part of the database server system.

A detailed discussion of a GMM transform will be now be given. In general, databases are coupled through a database management system to allow multiple users to access the data. Databases are commonly configured to allow the users to access the data with a variety of types of clients, such as personal computers, personal digital assistants (PDAs) and laptops. The various clients are typically connected to the database with a suitable network, such as a local or wide area network, the internet, or various wireless networks. The various clients are typically networked to a database server, with the database server including a database and a database management system.

The database server may take any number of forms, and should not be construed as limited only to a single computing device such as a personal computer. For example, the database server may constitute a series of networked personal computers, a minicomputer, mainframe computer, a distributed system of computing devices, or virtually any other suitable database system, as will be appreciated by a skilled artisan upon consideration of the present patent document. Likewise, the database may constitute a single database or a combination of databases that may be physically, logically, or otherwise remote or local relative to one another. The database or databases may be accessible by the database server locally, on the intranet, on the Internet as illustrated, or via any other extranet as may be available and suitable for use in a given application.

In operation, the database management system provides a structure, i.e., a structural metaphor, for how data in the database is “seen” by various constituents' database accessors operating the various computing devices. Accordingly, a user of the first personal computer, in accordance with a relational database structural metaphor, accesses data within the database by requesting a particular record within a particular table as defined by the database structure provided by the database management system. The record is broken up into fields. In response to the request, the database management system finds a location, both physically and logically, of the data of the record requested and retrieves the information from the database. Again, this operation may involve the database management system retrieving data from a single physical and/or logical database located locally at the database server, or may be as complex as retrieving data from multiple databases located at remote and/or local locations, and assembling such data into the “record” requested by the user.

The generalized mapping model provides a mechanism for reconstructing the database structure at the computing device and/or at the database management system. This reconstruction results in a transformed representation of the database structure and data (referred to hereinafter as representation structures and/or transformed database structure), which is highly manipulatable at the computing device by the user or the programmer of the user applications and without the need to alter the database structure. In this way, the user and/or programmer is able to affect changes to the database structure, as seen by the user application, without modifying the database structure at the database management system, and thus without requiring modification of all of the user applications i.e., without altering the database structure seen by other users.

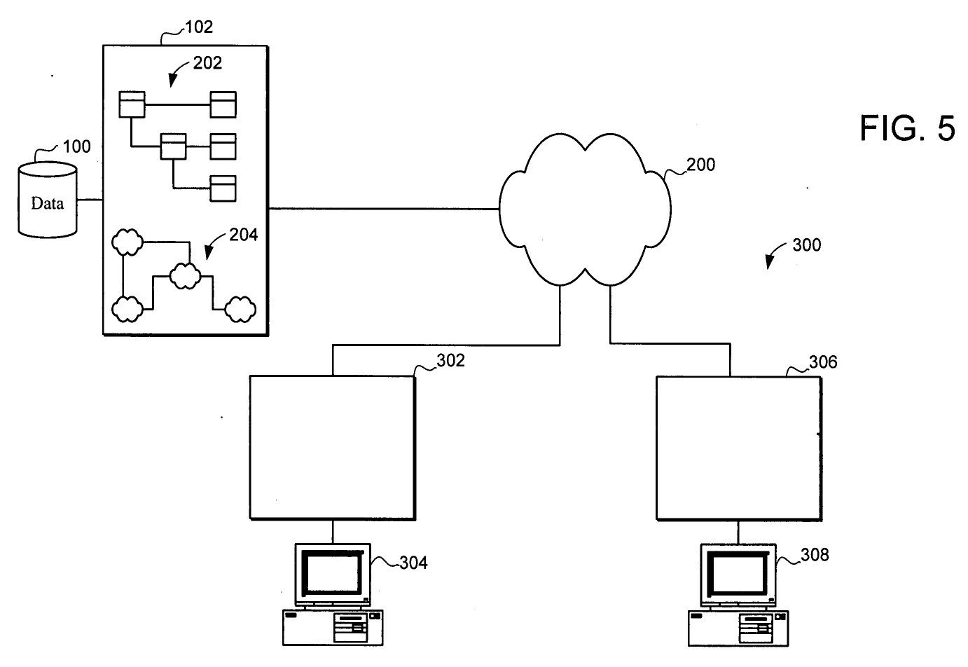

Referring next to FIG. 5, shown is a database 100, coupled to a database management system 102, which is coupled to a network 200. In operation, the database management system 102 provides a database metaphor 202, 204 for an arrangement of data in the database 100. This database metaphor 202, 204 may or may not correspond to the actual physical or logical arrangement of the data within the database 100. As depicted, this database metaphor 202, 204 may be that of a relational database or that of an object oriented database. Numerous other database metaphors are contemplated and are within the scope of the present embodiment.

Thus, when a user accessing the database management system 102 through the network 200 makes an operation on the database such as the retrieval of a record from the database 100, he or she does so by requesting the record from the database management system 102. The database management system 102 then identifies the location of the database 100, physically and logically, it retrieves the data, and presents the data to the user such as by communicating the data through the network 200, in the form expected in accordance with the database metaphor.

Other operations such as deletion or addition of data into and from the database are carried out in a similar manner. For example, should the user wish to add a record to the database 100, a user application located at the computing device of the user is typically used to formulate the record. Once the record is completed by the user application, it is transmitted through, for example, the network, to the database management system 102, which places the record into the database 100. As elaborated upon hereinabove, problems arise when the user wishes to manipulate the database structure of the database 100 as represented through the database metaphor.

Also illustrated in FIG. 5 is a first transformed database structure 302, a first computing device 304, a second transformed database structure 306, and a second computing device 308. As will be discussed in greater detail below, the first computing device 304 (and the second computing device 308) decomposes a database structure, provided by the database management system 102 and the data within the database 100, in order to thereby render separate many (or all) of its corresponding components and thereby facilitate generating the transformed database structure 302. As a result of having decomposed the original database structure and its data, user applications at, for example, the first computing device, are able to manipulate the transformed database structure, i.e., the database structure having been decomposed (or transformed) and/or the data within the database having been decomposed (or transformed).

These transformed structures offer a significant advantage over prior approaches which do not offer the ability at the computing devices 304, 308 to manipulate the database structure and the data, instead requiring that the user make a request of a database administrator who effects changes in database structure through the database management system 102, with the inherent problematic nature of this approach, as described hereinabove.

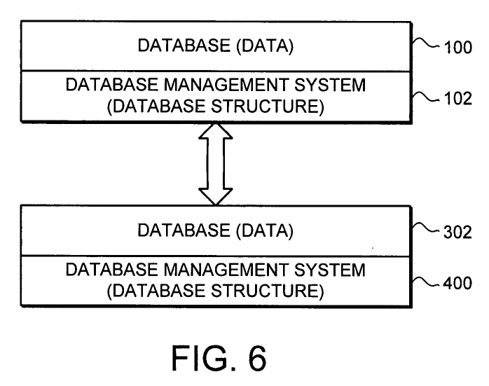

Referring next to FIG. 6, shown is a block diagram illustrating a relationship between the database 100, the database management system 102, the transformed database structure 302 and a user application 400 in accordance with the present embodiment. As can be seen, these elements are depicted here as layers 100, 102, 302, 400 that illustrate the relationship between the user application 400 and the database 100. In this embodiment, the database 100 is directly accessed by the database management system 102, which imposes a database structure on the data. (If desired, these same teachings could be applied in the absence of a database management system as well.) In this way, a database metaphor is applied such that the user application, heretofore, would only see the data in terms of the database metaphor, for example, in rows and columns, tables, or in objects. In accordance with the teachings of the present embodiment, the database structure and the data are retrieved through the database management system 102 and transformed into the transformed database structure 302.

As will be described in further detail herein, this transformed database structure 302 provides for a tremendously more flexible manipulation of the database structure and data by the user application 400 unconstrained by the original database structure imposed by the database management system 102, and independently of the database management system 102 and database administrator. Thus, when the user application alters the transformed database structure 302, the database structure seen by the database management system 102 is unchanged. In this way, the user application 400 is able to achieve a very powerful level of control over the transformed database structure 302, including the underlying data, without interfering, potentially, with activities of any other user applications that may be simultaneously accessing the database management system 102.

While only a single user application 102 and a single transformed database structure 302 are illustrated in FIG. 6, as was shown in FIG. 5 more than one transformed database structure and more than one computing device (including its user applications) may be coupled to the database management system 102 in this way. In fact, virtually an unlimited number of transformed database structures “seen” by the user application are possible in accordance with the present embodiments. In fact, more than one transformed database structure may be present on a single computing device and each user application may have multiple transformed database structures.

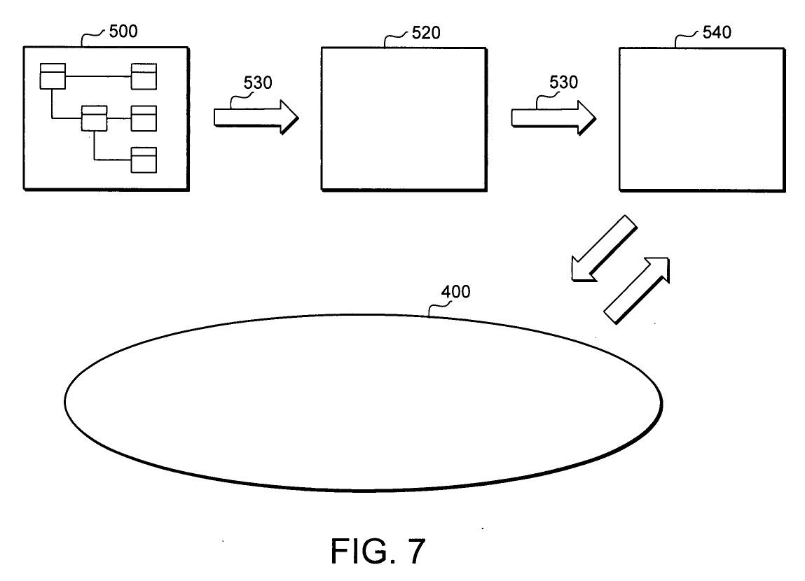

Referring next to FIG. 7, shown is a database structure (and data) 500 (as provided by a database management system, such as the database management system 102 of FIGS. 5 and 6), a decompose step 510, an atomic linkage 520, a domain reconstruction step 530, a transformed database structure 540, an assertion step 550, a custom database structure representation 400, and a user application (or user applications).

The present embodiment, advantageously, provides a system and method for reducing the database structure (and data) 500 to the atomic linkages 520 from which the custom database 560 can be asserted 550 under the control of a user application 400. This system and method will be referred to hereinafter from time to time as a generalized mapping model (GMM). Advantageously, the generalized mapping model allows each user to autonomously restructure the database structure (domain model): to have multiple simultaneous domain models; to compare domain models; to access through the same structures for all applications; and to connect domain information across multiple databases.

The generalized mapping model changes the database structure technologies heretofore known in at least three ways: it makes all implicit relationships explicit; it individually identifies as objects all data values and all linkages; and it places all objects into a set of very simple canonical structures.

The generalized mapping model is intended as a basis for, for example, data warehousing. The generalized mapping model accepts databases as inputs and maps such databases into a standardized form (transformed database structure 540). The user application 400 then is able to manipulate this standard form into the custom database representations 560, while the database structure (and data) 500 remain unchanged. This transformation or mapping may be applied to the analysis of a single database; a set of databases with dissimilar data; or a set of databases with similar data.

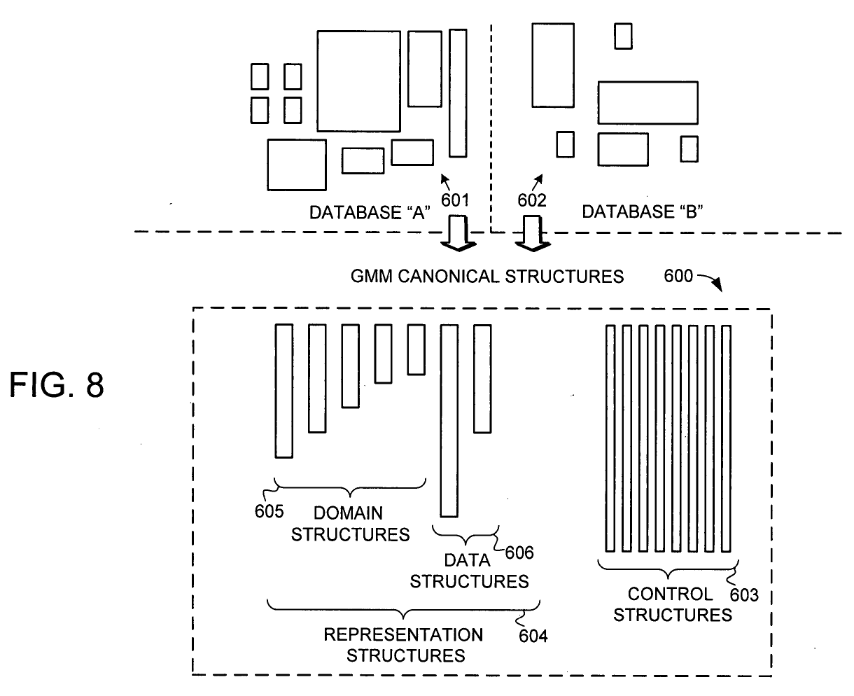

Referring to FIG. 8, a depiction is shown of the transformation of multiple databases into canonical structures of the generalized mapping model 600. Shown are a database 601, a database 602, control structures 603, representation structures 604, domain structures 605, and data structures 606. In accordance with this embodiment, the generalized mapping model accepts the database 601 and the database 602 as inputs, and maps them into the representation structures 604. The representation structures 604 is comprised of two sets of structures: the domain structures 605, which holds the domain of the database 601 and the database 602; and the data structures 606, which holds the data of the database 601 and the database 602. The control structures 603 allow the user to manipulate the representation structures 604 into a customized database representation.

The generalized mapping model's transformation or mapping results from seven transformational steps. These seven steps produce the corresponding representation structures, which make up the transformed database structure. The first five steps capture the database structure. The next two steps capture the data held by the database.

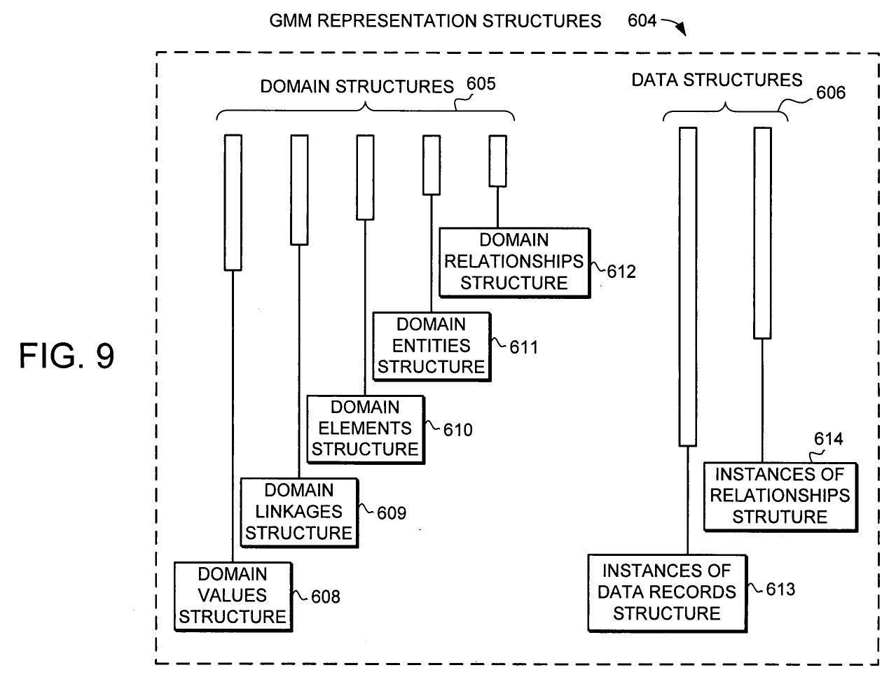

Referring next to FIG. 9, shown is a block diagram identifying the generalized mapping model representation structures 604. The seven structures that make up the representation structures 604 are split into two sets of structures: domain structures 605, and data structures 606. Domain structures 605 comprises five structures: a structure for domain values 608, a structure for domain linkages 609, a structure for domain elements 610, a structure for domain entities 611, and a structure for domain relationships 612. Data structures 606 comprise two structures: a structure for instances of data records 613, and a structure for instances of binary relations 614.

For each structure the following will be provided hereinbelow: The name of the representation structure; the representation structure's purpose; the representation structure's attributes; the transform steps; and an example of the resulting representation structure.

For expository purposes, the discussion hereinbelow first describes the transformation of individual entities and then describes relations between entities. The description begins with the transformation of the domain structure and concludes with the transformation of the data.

Also for expository purposes, the discussion hereinbelow follows a commonly used entity/relational model proposed by Peter Chen, and a resulting database, such as would be housed by the database management system of FIGS. 1 through 4 such as Oracle, DB2, or Sybase, such as are commonly known by those of ordinary skill in the art. A function providing a unique identifier for each new object is assumed.

For simplicity, the discussion is limited to data types that are nominal values. Within this document, an object is defined as a set of labeled cells, one of which contains a unique identifier by which the object can be distinguished from every other object. These object identifiers are abbreviated as OID. Note that object identifiers need not be sequential or numeric. Each of the other cells making up an object may hold either data values or another object identifier. If any of the other cells holds an object identifier, the object is referred to as a linkage.

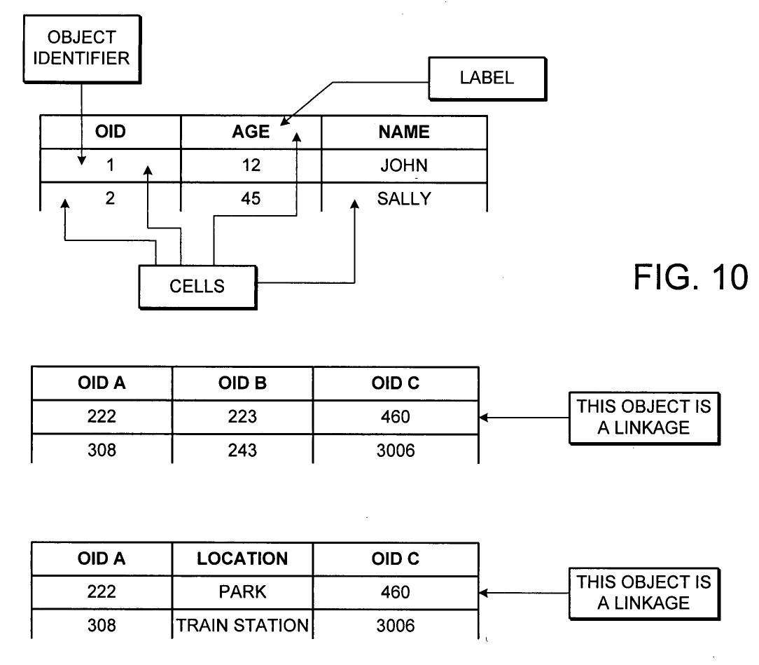

When objects have the same labels in their cells they may be organized into arrays with the labels extracted into column headings as depicted in FIG. 10. For most databases, labels are referred to as attributes.

As a generic approach to modeling a database structure, within this document, a value shall be a possible state of an attribute determined by a process; and a relationship shall be an entity whose attributes always include a linkage (i.e., a relationship must contain a linkage and it may contain attributes).

By way of simple example, the following table describes an entity with two attributes:

TABLE 1
Person

| | |
|---|---|
| Name | Height |

In accordance with one example, each attribute has two possible values. These values are part of the representation of a database structure. In Table 2, below, the values of the attributes are listed. Note that the bottom two rows in Table 2 are not data records, they are independent lists of possible data values.

TABLE 2
Person

| Name | Height |
|---|---|
| Sally | Tall |
| Tomas | Short |

As referred to above, in accordance with the present embodiment, five transformations are used to capture the database structure. The first transformation captures the database nomenclature. The next three transformations are used to capture the construction of individual entities. The fifth transformation captures relationships between entities, and the last two transformations capture the data records and relationships between data records.

The base example in Table 2 is used to determine the first four structures. Later, an expanded example illustrating a relationship and another entity will be introduced as a basis for the transformation of entity relationships.

Note in the examples herein, comment fields are added to assist in clarifying the examples, but are not part of the transformed database structure or database structures.

At the outset, transformation of the database nomenclature is described. The purpose of the domain values structure is to capture all domain nomenclatures. The attributes of a table resulting from this transformation are “object identifier” and “values”. The transformation includes:

1. Creating an object for every structure name:
i. Entity structure
ii. Relation structures (including inverse relations and associative structures);

2. Creating an object for every attribute name within every structure; and

3. Creating an object for every value occurring within every attribute.

Table 3 sets forth an example of the database structure represented in Table 2 having had the above-described transformation performed thereon. It is important to emphasize that the generalized mapping model makes each lexical element of the schema a separately identified object by itself. Thus if red, green, and yellow values are values for color, then each will be given a separate object identifier. If a value occurs for more than one attribute, it is only listed once.

TABLE 3

| OID | VALUE | Comment |
|---|---|---|
| 1 | Person | Entity |
| 2 | Name | Attribute |
| 3 | Sally | Value |
| 4 | Tomas | Value |
| 5 | Height | Attribute |
| 6 | Tall | Value |
| 7 | Short | Value |

Next, the domain linkages structure is described. The transformation of implicit domain linkages in the originating schema into explicit objects uses the nomenclature in the domain value structure by referencing the domain term via its object identifier. It uses these object identifier references to create objects for linking domain values to domain attributes and to create objects for linking domain attributes to domain entities (or relations).

Note that the links are directed and this property is designated by the use of “from” and “to” attributes. The direction is assumed to be top down (for example, from “entity to attribute” rather than from “attribute to entity”).

The attributes of the domain linkage are “object identifier”; “object identifier from”; and “object identifier to”.

The steps involved in this transformation are:
1. Creating an object for every linkage of an attribute to a data value; and
2. Creating an object for every linkage of an entity (or relation) to an attribute.

Table 4 illustrates the creation of this structure as a function of the database structure set forth in Table 4. Note that in order to represent the database structure, an attribute is mapped to all of its occurring values.

TABLE 4

| OID (link) | OID (FROM) | OID (TO) | Comment |
|---|---|---|---|
| 8 | 2 | 3 | Name to Sally |
| 9 | 2 | 4 | Name to Tomas |
| 10 | 1 | 2 | Person to name |
| 11 | 5 | 6 | Height to Tall |
| 12 | 5 | 7 | Height to Short |
| 13 | 1 | 5 | Person to Height |

Next, the domain elements structure is described. The purpose of this structure is to build complete data elements from the linkages.

The attributes of this structure are “object identifier”; “object identifier from”; and “object identifier to”.

In this example, in the domain linkages structure described hereinabove, the value “Sally” has been connected to the attribute “name” and the attribute “name” has been connected to the entity “person” but these connections must themselves be linked so as to create the domain element “Sally-name-person”.

The step involved in this transformation is: creating an object for every linkage between the existing linkage of data values to an attribute, and an attribute to an entity (or relation).

Table 5 illustrates this structure resulting from this transformation.

TABLE 5

| OID (link) | OID (FROM) | OID (TO) | Comment |
|---|---|---|---|
| 14 | 10 | 8 | The object “Name to |
| | | | Sally” is linked with the |
| | | | object “Person to Name” |
| | | | in order to build the |
| | | | linkage object “Person to |
| | | | Name to Sally” |
| 15 | 10 | 9 | Person to Name to Tomas |
| 16 | 13 | 11 | Person to Height to Tall |
| 17 | 13 | 12 | Person to Height to Short |

Next we will describe the transform that results in the domain entities structure. In order to refer to an entity as a unit (and thereby provide it with its own object identifier), it is necessary to collect all of the domain elements of an entity together. (These linkages are held and identified in the domain elements structure). Thus, the purpose of this structure is to collect all of the parts of an entity (or relationship) together as a unit. Note that this structure collects domain elements into a set of domain elements without order. Note further that a set of domain elements is also an object itself.

The attributes of this structure are “object identifier”; and “object identifier (element).”

The steps involved in this transformation are:
1. Creating a new object identifier for each entity; and
2. Collecting the linkages that comprise the entity into a unit by repeating the object identifier record for each object identifier element.

In the present example of the people entity, there are four domain elements. These are collected under the common object identifier 100. Table 6 reflects this structure created as a result of this transformation step.

TABLE 6

| OID (entity) | OID (element) | Comment |
|---|---|---|
| 100 | 14 | Person - Name -Sally |
| 100 | 15 | Person - Name -Tomas |
| 100 | 16 | Person - Height -Tall |
| 100 | 17 | Person - Height -Short |

Note that individual relations are entities. From this characterization, it follows that the transformed structures can accommodate relationships which have their own attributes (e.g., “associative entities” in the relational model).

By way of further example, the above example will now be expanded to include relationships between entities, prior to describing the next transforms.

A new entity of “cars” and a relationship of “drive” are added to the domain database structure (see Tables 7 and 8). Note that these tables contain independent lists of possible data values, not data records.

TABLE 7
Drive

| Day | Location |
|---|---|
| Tuesday | Park |
| Friday | Town |

TABLE 8
Cars

| Manufacturer | Color |
|---|---|
| Cadillac | Blue |
| Toyota | Green |
| Mercedes | White |

To accommodate this additional database structure information, the corresponding generalized mapping model structures are augmented (see Table 9, 10, 11 and 12). To distinguish these additions, the previous objects in these tables are indicated with asterisks. Note that there is no required renumbering of the object identifiers of the previous objects.

TABLE 9

| OID | VALUE | COMMENT |
|---|---|---|
| 1 * | Person | Entity |
| 2 * | Name | Attribute |
| 3 * | Sally | Value |
| 4 * | Thomas | Value |
| 5 * | Height | Attribute |
| 6 * | Tall | Value |
| 7 * | Short | Value |
| 20 | Car | Entity |
| 21 | Manufacturer | Attribute |
| 22 | Color | Attribute |
| 23 | Drive | Relation |
| 24 | Cadillac | Value |
| 25 | Toyota | Value |
| 26 | Mercedes | Value |
| 27 | White | Value |
| 28 | Blue | Value |
| 29 | Green | Value |
| 30 | Day | Attribute |
| 31 | Location | Attribute |
| 32 | Tuesday | Value |
| 33 | Friday | Value |
| 34 | Park | Value |
| 35 | Town | Value |

TABLE 10

| OID (link) | OID (FROM) | OID (TO) | Comment |
|---|---|---|---|
| 8 * | 2 | 3 | Name to Sally |
| 9 * | 2 | 4 | Name to Tomas |
| 10 * | 1 | 2 | Person to Name |
| 11 * | 5 | 6 | Height to Tall |
| 12 * | 5 | 7 | Height to Short |
| 13 * | 1 | 5 | Person to Height |
| 36 | 31 | 34 | Location to Park |
| 37 | 31 | 35 | Location to Town |
| 38 | 30 | 32 | Day to Tuesday |
| 39 | 30 | 33 | Day to Friday |
| 40 | 23 | 30 | Drive to Day |
| 41 | 23 | 31 | Drive to Location |
| 42 | 21 | 24 | Manufacturer to Cadillac |
| 43 | 21 | 25 | Manufacturer to Toyota |
| 44 | 21 | 26 | Manufacturer to Mercedes |
| 45 | 20 | 21 | Car to Manufacturer |
| 46 | 20 | 22 | Car to Color |
| 47 | 22 | 27 | Color to White |
| 48 | 22 | 28 | Color to Blue |
| 49 | 22 | 29 | Color to Green |
| 50 | 23 | 2 | Drive to Name |
| 51 | 23 | 21 | Drive to Manufacturer |

TABLE 11

| OID | OID | OID | |
|---|---|---|---|
| (link) | (FROM) | (TO) | Comment |
| 14 * | 10 | 8 | Person to Name to Sally |
| 15 * | 10 | 9 | Person to Name to Tomas |
| 16 * | 13 | 11 | Person to Height to Tall |
| 17 * | 13 | 12 | Person to Height to Short |
| 52 | 40 | 39 | Drive to Day to Friday |
| 53 | 40 | 38 | Drive to Day to Tuesday |
| 54 | 41 | 36 | Drive to Location to Park |
| 55 | 41 | 37 | Drive to Location to Town |
| 56 | 46 | 49 | Car to Color to Green |
| 57 | 46 | 47 | Car to Color to White |
| 58 | 46 | 48 | Car to Color to Blue |
| 59 | 45 | 44 | Car to Manufacturer to Mercedes |
| 60 | 45 | 42 | Car to Manufacturer to Cadillac |
| 61 | 45 | 43 | Car to Manufacturer to Toyota |

TABLE 12

| OID | OID | |
|---|---|---|
| (entity) | (element) | Comment |
| 100 * | 14 | Person - Name - Sally |
| 100 * | 15 | Person - Name - Tomas |
| 100 * | 16 | Person - Height - Tall |
| 100 * | 17 | Person - Height - Short |
| 200 | 52 | Drive - Day - Friday |
| 200 | 53 | Drive - Day - Tuesday |
| 200 | 54 | Drive - Location - Park |
| 200 | 55 | Drive - Location - Town |
| 300 | 56 | Car - Color - Green |
| 300 | 57 | Car - Color - White |
| 300 | 58 | Car - Color - Blue |
| 300 | 59 | Car - Manufacturer - Mercedes |
| 300 | 60 | Car - Manufacturer - Cadillac |
| 300 | 61 | Car - Manufacturer - Toyota |

Next, the domain relationship structure will be described. The purpose of this structure is to make explicit the linkages that associate one entity with another entity through a relationship. This structure holds “class level” relationships (such as “dogs chase cats”). These “class level” relationships are distinct from “instances of relationships” (where a particular dog chases a particular cat; Butch chases Sylvester). The “instances of relationships” are captured in the data transformation referred to as the instances of relationships structure, described hereinbelow.

The present transformation couples two entities in a named direct relationship. Bi-directional relationships (such as partnership and marriage) are held as two distinct one-way relationships.

The attributes of the relationship's structure are “object identifier”; “object identifier from”; “object identifier to”; and “object identifier relationship”.

Steps involved in this transformation are to create an object for every connection between entities; and to include the relationship as part of the object.

Since, in the present example Object Identifier 100 refers to the people entity and Object Identifier 200 refers to the drive entity and Object Identifier 300 refers to the car entity, the result is depicted in Table 13 as a new object, with an Object Identifier as 400.

TABLE 13

| OID | OID | OID | OID | |
|---|---|---|---|---|
| (link) | (FROM) | (TO) | (RELATIONSHIP) | Comment |
| 400 | 100 | 300 | 200 | People to Drive to Car |

After the domain model has been transformed, the same objects held in the first five structures can be utilized to capture data by the use of two more simple transforms. In the first data transform, individual data records are captured. In the second data transform, instances of relationships are captured.

Before the next two transforms are described, the example described hereinabove is augmented to include data. Therefore, in the tables below, the rows under the domain attributes now represent data records. Thus, in the people entity, the first data record represents an individual named Sally who is short.

TABLE 14
Person

| Name | Height |
|---|---|
| Sally | Short |
| Tomas | Tall |

TABLE 15
Cars

| Manufacturer | Color |
|---|---|
| Mercedes | White |
| Cadillac | Blue |
| Toyota | Green |

TABLE 16

| Name | Day | Location | Manufacturer |
|---|---|---|---|
| Sally | Tuesday | Park | Mercedes |
| Tomas | Tuesday | Town | Cadillac |
| Tomas | Friday | Park | Toyota |

From the expansions of data records in individual entities, the instance relationships between the data are represented; e.g., a short person named Sally drives a white Mercedes in the park on Tuesday.

Note that the capture of these “complete” relationships from a relational database requires expanding the cross product among relational tables. Effectively, this expansion creates denormalized records. In those cases where a single entity record is mapped through a relationship to multiple records in another entity, each composite record is represented individually. Thus there are separate objects for:

A short person named Sally drives a white Mercedes in the park on Tuesday. A short person named Sally drives a white Mercedes in the park on Friday.

However, their generalized mapping model storage is far more efficient than the cross products of the corresponding relational models since only two object identifiers are needed.

How these statements are constructed in the generalized mapping model is described in the next two transforms.

The next structure is for instances of individual data records. The purpose of this structure is to collect a set of data elements into a “record.” Note that a record instance is also an object by itself and that this structure collects elements into records without order.

The attributes of this structure are object identifier (record); and object identifier (element). The steps in this transformation are:
1. Creating a new object identifier for each record or row in a table: “Object identifier (record)”; and
2. Grouping the elements that occur in the database into a unit by repeating the object identifier record for each object identifier element.

In the example of the people entity there are two records. (See Table 17.)

TABLE 17

| OID | OID | |
|---|---|---|
| (record) | (element) | Comment |
| 62 | 14 | Sally, Short |
| 62 | 17 | |
| 63 | 15 | Tomas, Tall |
| 63 | 16 | |
| 64 | 61 | Green Toyota |
| 64 | 56 | |
| 65 | 59 | White Mercedes |
| 65 | 57 | |
| 66 | 60 | Blue Cadillac |
| 66 | 58 | |
| 67 | 52 | Drive on Friday |
| 67 | 54 | in Park |
| 68 | 53 | Drive on Tuesday |
| 68 | 55 | in Town |
| 69 | 53 | Drive on Tuesday |
| 69 | 54 | in Park |

Next, the instances of relationships structure will be described. The purpose of this structure is to provide individual binary relationships between data records. Note that a relationship instance is also an object by itself.

The attributes of this structure are “object identifier”; “object identifier from”; “object identifier to”; and “object identifier relationship”.

Note that the goal is to link a complete record in an originating structure (for example, people) with a complete record in a terminating structure (for example, cars) through a particular relation (for example, drive). This linkage is directed. Undirected relationships, (for example, partnership, marriage, symbiosis) may be accommodated by either ignoring directionality or providing both directions by copying the linkage with the to/from object identifiers reversed. The steps in this transformation are:

1. Creating a new object for each relationship; and

2. Populating the new object with:
a. The object identifier of the originating object identifier from the instances of individual data records structure;
b. The object identifier of the terminating object identifier from the instances of individual data records structure; and
c. The object identifier of the specific relationship from the instances of individual data records structure.

Table 18 illustrates an example of the instances of relationships structure.

TABLE 18

| OID | OID | OID | OID | |
|---|---|---|---|---|
| (link) | (FROM) | (TO) | (Relationship) | Comment |
| 70 | 62 | 65 | 69 | Short Sally drives the |
| | | | | White Mercedes in |
| | | | | Park on Tuesday |
| 71 | 63 | 64 | 67 | Tall Tomas drives the |
| | | | | Green Toyota in |
| | | | | Park on Friday |
| 72 | 63 | 66 | 68 | Tall Tomas drives the |
| | | | | Blue Cadillac in |
| | | | | Town on Tuesday |

The objects in the domain value structures were presented as a means for capturing the domain nomenclature. In the simple example used in the initial exposition of the generalized mapping model, all the data values of these objects were of the data type string. However, the values may be represented in many other formats, called data types. In addition to strings, common data types include integers, reals, bitmaps, images, waveforms, etc. In order to provide for data in these additional formats it is necessary to replace the single data values structure with 1) a pointer structure that then references 2) a set of data value structures, one for each data type. At a minimum, in order to capture the domain nomenclature, a string data structure must exist.

Thus, the data values data type structures will be described.

The purpose of these structures is to hold domain values separately based on their data type. They are used for the representation of both the domain and the data.

The attributes of domain and values data type structure are “object identifier”; and “object identifier value”.

The steps in the transformation to the data values data type structures are:
1. Creating a structure for each data type;
2. Creating within each data type structure an object for every data value of that type; and
3. Creating, as described above, a separate data structure of data type string for the domain nomenclature. Note that this domain structure may be merged with the data structure of the type string.

Note that the value pointers are not objects, their format and values are independent of the object identifiers and they may differ among different data types. The only requirement is that the address is resolvable to a single value. Also note that these referenced structures need not be simple lists.

A string datatype structure is illustrated in Tables 19 and 20.

TABLE 19
Nominal Data Value Structure

| ADDRESS | VALUE |
|---|---|
| 1330303i4 | Person |
| 345224 | Name |
| 355355 | Sally |

TABLE 20
Integer Data Value Structure

| ADDRESS | VALUE |
|---|---|
| AZ12 | 345 |
| IL02 | 2 |
| FL23 | 67 |

Next, the domain values reference structure will be described. The purpose of this structure is to provide a pointer to domain values based on their data type.

The attributes of the domain values reference structure are “object identifier”; “object identifier value pointer”; and “data type structure”.

The steps involved in transforming to the domain values referenced structure are:
1. Create an object for every data value held in any of the domain and data values data type structures:
   a. identify the structure by name, and
   b. identify the location in the structure by an address or pointer value.

Table 21 illustrates the domain value reference structure.

TABLE 21

| OID | VALUE POINTER | DATATYPE STRUCTURE |
|---|---|---|
| 1 | 1330303i4 | String |
| 2 | 345224 | String |
| 3 | 355355 | String |
| 80 | AZ12 | Integer |
| 81 | IL02 | Integer |
| 82 | FL23 | Integer |

At this point all of the information in the database structure as well as the corresponding data has been allocated to the generalized mapping model standard structures, and the transformed database structure is a complete representation of the original domain structure and its data.

The following describes an exemplary means of reconfiguring the domain structure and the data using objects in the generalized mapping model's transformed database structure.

Bitmaps have been used extensively in computer applications such as operating systems and image representations. Although these structures are not part of the above-described transform, per se, they are especially useful as auxiliary structures and are included in the present document to show how the transform enables the adaptability of the domain model.

Next, the object control structures will be described.

The purpose of the object control structures is to identify which parts of the database match a condition. Note that there is only one structure for each condition. A condition is a declaration: “These objects are asserted for financial analysis.” There is one object control structure for each condition.

Also note that the number of bits in an object control structure is the same as the number of objects. (An alternative approach is to create a separate structure per transformed structure per condition.) The only attribute of the object control structures is status.

The steps in the transform to the object control structures are:
1. Define the condition (for example, “if deleted”) and create a corresponding bitmap; and
2. Set the bits corresponding to the objects that are asserted for the particular condition.

An example of an object control structure is shown in Table 22.

TABLE 22
Status:
1
1
1
0
1
0
1
0
. . .
1

In general the use of object control structures is to identify which objects are asserted for a particular purpose.

As a simple example, to identify which objects are deleted, a bit is first asserted for every object and then a bit is retracted corresponding to each deleted object. The object may be a data record, entity, domain value, domain element, or any other object. Note that with the use of a control map for deletion, no object is actually removed; only a bit is retracted in the map to indicate deletion.

As an example, following the data given previously, if we want “Tomas to drive on Friday” and “not drive on Tuesday,” a control map can be created for the days that people drive and the conditions above can be captured by asserting the bit for object 71 and retracting the bit for object 72.

As with any database action, there may be logical consequences to a deletion such as a “cascade effect” where by the retraction of one object may require the retraction of other, perhaps many, objects, each of which in turn may require the retraction of other objects (and so on). The dependency of objects may be assessed by another data structure, commonly used in data modeling to show one-to-many “part/whole” relationships such as occur in “bill of material” models and depicted in Table 23.

TABLE 23
Object Dependency

| OID | OID (DEPENDENT) |
|---|---|
| 232 | 3556 |
| 232 | 340 |
| 3098 | 7688 |
| 3098 | 9964 |
| 340 | 567 |
| 340 | 4334 |
| 340 | 345 |
| 567 | 2234 |

For control of the objects in the generalized mapping model, there is one bit for every object ever generated. Note that each object control structure is itself an object and is identified by an object identifier. At a minimum there is a control bit map for all “created” objects. The control maps can be combined to create assertions of complex conditions (e.g., a Boolean operator such as “inclusive or” may be used to combine two maps). A set of these maps can increase the computational speed by holding different partial results in each map and then, by the use of logical operators (AND, NOT, IOR, and XOR) provide results for complex assertions.

Note that a separate control map may be created for any desired condition. The condition is, effectively, the map. Thus, asserting/retracting bits can customize a configuration of the domain structure, which allows “sub databases” to be defined from a composite database, thereby permitting a constructive definition of context (i.e., what linkages (represented by objects) are activated/deactivated in a sub database for a given set of conditions). Since a bitmap is a type of data format, after each control map is created, it becomes an object in the domain value bitmap structure.

In the embodiments of the invention the control maps are implemented as access control maps to define which data components and relationships different access control procedures are applied. The access control maps specify the permissions and/or conditions that apply to the data and relationships in the GMM transformed data, and can be combined to provide flexible access control. The access control maps thus can facilitate selective access control at any level of resolution, from the lowest levels of granularity in the system, to large groups of data, to class relationships within the domain. Furthermore, the access control maps facilitate separate security control of both the implicit and explicit relationships among data in the underlying database without making any requirement for access control restrictions that are used in the relationship.

The embodiments of the invention can use the GMM transform described above to provide access control for the data base. Specifically, by restructuring the database into a GMM transform that identifies data components and domain structure information as objects, and providing access control maps to control access to these objects, the system and method is able to provide improved access control to the database.

The database access control system and method thus uses the objects created by the GMM transform to identify and facilitate selective access control to any part or combination of components in the database, including the data values and implicit relationships between data values. The system and method facilitates individual control of the security permissions and conditions for the components using one or more access control maps to define which values and relationships different access control procedures are applied. The access control maps specify the permissions and/or conditions that apply to the data values and relationships in the GMM transformed data, and can be combined to provide flexible access control. Furthermore, the system and method facilitates separate security control of the implicit relationships among data in the underlying database, without requiring the same access control restrictions on the corresponding data values themselves. Furthermore, by providing multiple access control maps to different clients allows different sets of permissions and conditions to be established for the clients that are unrelated to other permissions. The access control system and method thus provides flexible access control to the database.

The embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit of the forthcoming claims.

1. A system for controlling access to components in a database, the system comprising:
a first plurality of objects generated as function of data in the database and a second plurality of objects generated as a function of domain structure of the database; and
an access control map, the access control map specifying an access control parameter for the first and second plurality of objects.

2. The system of claim 1 wherein the access control parameter comprises a permission.

3. The system of claim 1 wherein the access control parameter comprises a condition.

4. The system of claim 1 further comprising a second access control map, the second access control map specifying a second access control parameter for the first plurality of objects and second plurality of objects.

5. The system of claim 4 wherein the access control map and the second access control map are selectively combined to provide composite condition access control for the first plurality of objects and second plurality of objects.

6. The system of claim 5 wherein the access control map and the second access control map are selectively combined using Boolean operations.

7. The system of claim 1 wherein the second plurality of objects are organized in a plurality of domain structures, the plurality of domain structures comprising:
a domain value structure;
a domain linkage structure;
a domain elements structure;
a domain entities structure; and
a domain relationship structure.

8. The system of claim 1 wherein the first plurality of objects are organized in a plurality of data structures, the plurality of structures comprising:
an instances of data records structure; and
an instances of relationships structure.

9. A system for controlling access to components in a database, the system comprising:
a first plurality of objects, each of the first plurality of objects corresponding to a data components in the database, each of the first plurality of objects including a unique identifier;
a second plurality of objects, each of the second plurality of objects corresponding to a domain structure components in the database, each of the second plurality of objects including a unique identifier; and
a plurality of access control maps, the plurality of access control maps each specifying an access control parameter for the first plurality of objects and the second plurality of objects, wherein the plurality of access control maps can be selectively combined in varying combination to provide flexible access control for the components in the database.

10. The system of claim 9 wherein each access control parameter comprises a permission or a condition.

11. The system of claim 9 wherein the plurality of access control maps can be selectively combined using Boolean operations.

12. The system of claim 9 wherein the second plurality of objects are organized in a plurality of domain structures, the plurality of domain structures comprising:
a domain value structure, the domain value structure comprising a plurality of domain value objects, the plurality of domain value objects corresponding nomenclature of entities, attributes and values in the database, the plurality of domain value objects each including an object identifier;
a domain linkage structure, the domain linkage structure comprising a plurality of domain linkage objects, the plurality of domain linkage objects corresponding to linkages between attributes and values and linkages between entities and attributes, the plurality of domain linkage objects each including an object identifier;
a domain elements structure, the domain elements structure comprising a plurality of domain elements objects, the plurality of domain elements objects corresponding to linkages between domain linkage objects, each of the plurality of domain elements objects including an object identifier;
a domain entities structure, the domain entities objects comprising a plurality of domain entities objects, the plurality of domain entities objects corresponding to relationships between domain elements objects corresponding to linkages, each of the plurality of domain entities objects including an object identifier; and
a domain relationship structure, the domain relationship structure comprising a plurality of domain relationship objects, the plurality of domain relationship objects corresponding to relationships among classes of entities, each of the plurality of domain relationship objects including an object identifier.

13. The system of claim 9 wherein the first plurality of objects are organized in a plurality of data structures, the plurality of structures comprising:
an instances of data records structure, the instances of data records structure including a plurality of data records objects, each of the plurality of data records objects corresponding to a record in the database, each of the plurality of data records objects including an object identifier; and
an instances of relationships structure, the instances of data relationships structure including a plurality of relationships objects, each of the plurality of relationships objects corresponding to a relationships between records in the database, each of the plurality of relationships objects including an object identifier.

14. A method for controlling access to components in a database having data and a domain structure, the method comprising the steps of:
reconstructing the database structure into a transformed database structure, the transformed database structure including a first plurality of objects generated as function of data in the database and a second plurality of objects generated as a function of domain structure of the database; and
specifying access control parameters for the first and second plurality of objects using an access control map.

15. The method of claim 14 wherein the access control parameters comprise permissions and conditions.

16. The method of claim 14 further comprising specifying access control parameters for the first and second plurality of objects using a second access control map a second access control parameter for the first plurality of objects and second plurality of objects.

17. The method of claim 16 further comprising the step of selectively combining the access control map and the second access control map to provide composite condition access control for the first plurality of objects and second plurality of objects.

18. The method of claim 17 wherein the access control map and the second access control map are selectively combined using Boolean operations.

19. The method of claim 14 wherein the second plurality of objects are organized in a plurality of domain structures, the plurality of domain structures comprising:
a domain value structure, the domain value structure comprising a plurality of domain value objects, the plurality of domain value objects corresponding nomenclature of entities, attributes and values in the database, the plurality of domain value objects each including an object identifier;
a domain linkage structure, the domain linkage structure comprising a plurality of domain linkage objects, the plurality of domain linkage objects corresponding to linkages between attributes and values and linkages between entities and attributes, the plurality of domain linkage objects each including an object identifier;
a domain elements structure, the domain elements structure comprising a plurality of domain elements objects, the plurality of domain elements objects corresponding to linkages between domain linkage objects, each of the plurality of domain elements objects including an object identifier;
a domain entities structure, the domain entities objects comprising a plurality of domain entities objects, the plurality of domain entities objects corresponding to relationships between domain elements objects corresponding to linkages, each of the plurality of domain entities objects including an object identifier; and
a domain relationship structure, the domain relationship structure comprising a plurality of domain relationship objects, the plurality of domain relationship objects corresponding to relationships among classes of entities, each of the plurality of domain relationship objects including an object identifier.

20. The method of claim 14 wherein the first plurality of objects are organized in a plurality of data structures, the plurality of structures comprising:
an instances of data records structure, the instances of data records structure including a plurality of data records objects, each of the plurality of data records objects corresponding to a record in the database, each of the plurality of data records objects including an object identifier; and
an instances of relationships structure, the instances of data relationships structure including a plurality of relationships objects, each of the plurality of relationships objects corresponding to a relationships between records in the database, each of the plurality of relationships objects including an object identifier.
